(19) United States
(12) Patent Application Publication
(10) Pub. No.: US 2004/0073408 A1
(43) Pub. Date: Apr. 15, 2004

(54) State identification of electrically conductive oblong tensioning elements using resonance frequencies and a computer program

(76) Inventors: Bert Jannsen, Hildesheim (DE); Arne Jacob, Braunschweig (DE); Harald Budelmann, Wolfenbuttel (DE); Guido Schneider, Braunschweig (DE); Hans-Joachim Wichmann, Braunschweig (DE); Karim Hariri, Braunschweig (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/466,247

(22) PCT Filed: Jan. 10, 2002
(86) PCT No.: PCT/DE02/00055

(30) Foreign Application Priority Data
Jan. 20, 2001 (DE) 101 02 577.7

(51) Int. Cl. G06F 15/00

(52) U.S. Cl. 702/196

(57) ABSTRACT

The invention relates to a method for identifying the state (point of rupture 2) of electrically conductive oblong tensioning elements (1) involving the following steps: launching an electromagnetic measurment signal into a tensioning element (1a); changing the frequency; measuring the reflection spectrum, and; indentifying the state of the tensioning element (1a) according to the resonance frequencies. Said signal is lauched on the fore-part or on the periphery. In the event of coupled tensioning element (1), a scattering matrix system of equations is iteratively devised. The invention is used in the construction industry for prestressed concrete structures and rear anchored systems.

The invention relates to a method for identifying the state of electrically conductive elongate tensioning, elements and a computer program with program coding means for carrying out the method.

Elongate tensioning elements are used in particular in the construction industry for prestressed concrete structures and rear-anchored systems. The function of the tensioning elements is the main decisive factor for the safety of these prestressed concrete structures and rear-anchored systems. The tensioning elements may suffer damage, for example from corrosion or unplanned loading, with the result that the dimensional stability of the structures is no longer ensured. It is therefore especially important to check and monitor the tensile force present on the tensioning elements and any possible damage to the tensioning elements. To be able to perform specific repairs, it is also desired to establish and locate points of rupture of the tensioning elements.

In Krumbach, R.; Heyn, A.: “Spannungsrisskorrosion von Spannstahl—Vorstellung einer neuen Untersuchungs —methode” [Stress crack corrosion of prestressing steel—presentation of a new method of investigation]; in Konferenz-Einzelbericht: DAfStb-Forschungskolloquim, Beiträgezum 35. Forschungskolloquim [Individual conference report: German committee for reinforced concrete Research colloquium, contributions to the 35th research colloquium], Leipzig, Mar. 19 to 20, 1998, pages 229 to 238, there is a description of a method for investigating the tendency for stress crack corrosion to occur on prestressing steels by sensing the electrochemical noise. In this way, the sensitivity of the prestressing steels and the susceptibility to faults can be determined.

It is known from Miegeler, H. J.; Wolff, R.: “Glasfaserstäbe: ein neuartiger Stoff zur Brtückenvorspannung. Sensoren uberwachen das Bauwerk” [Glass fiber rods: a novel material for prestressing bridges. Sensors monitor the structure]; in: Beratende Ingenieure 1992, issue 7/8, pages 43 to 47, to permanently monitor tensioning elements in reinforced concrete bridge construction by means of additionally incorporated copper wire sensors and optical waveguide sensors, the optical waveguides and copper wires being incorporated in tension zones of the tensioning elements.

DE-A 42 09 661 A1 describes a method for permanently monitoring concrete structures in which cracks are detected with the aid of an electrically conducting film, which are applied to the component in a shear-resistant adhering manner. In the event of crack formation, the films are separated in such a way that the electrical resistance to be measured between the ends of the film increases. A disadvantage of this method is that additional treatment of the tensioning elements is required.

DE-A 27 29 150 A1 describes a method for measuring changes in tensile force with the aid of a bridge circuit. In this method, the tensioning elements are part of the bridge circuit and are evaluated as electrical impedances. In the event of a change in the tensile force, there is a change in impedance and consequently a detuning of the bridge circuit, which can be measured. A disadvantage here is that the bridge circuit initially has to be tuned in the undamaged state and a comparison with the damaged state is required. A subsequent measurement just on a damaged structure is not possible.

A corresponding method is also known from U.S. Pat. No. 4,055,078.

A further method for monitoring tensioning wires in prestressed concrete parts is based on magnetic stray flux measurement. The method is described for example in Savade, G.: “Anwendung der Methode der magnetischen Streufeldmessung zur Ortung von Spannstahlbrüchen” [Application of the method of magnetic stray field measurement for locating prestressing steel ruptures”]; in Konferenz-Einzelbericht: Bauwerksdiagnose. Praktische Anwendungen zerstörungsfreier Prüfungen [Individual conference report: structure diagnosis. Practical applications of nondestructive tests], Munich, Jan. 21 to 22, 1999, Deutsche Gesellschaft fuar zerstörungsfreie Prutfung e.V. [German association for nondestructive testing], volume 66, pages 73 to 81. This involves moving a test head with a magnetizing device together with magnetic field sensors along the steel reinforcement. Faults in the form of ruptures of a tensioning wire are clearly identifiable as a maximum of the magnetic field. The measurement takes place by forming a differential signal from two measuring runs and by variation of the exciting measuring field, whereby the influence of transverse bracket signals is reduced.

A similar method is described in Hillemeier, B.; Scheel, H.: “Magnetische Ortung von Spanndrahtbrüchen in Spannbeton” [Magnetic location of tensioning wire ruptures in prestressed concrete] in: Materials and Corrosion, volume 49, 1998, issue 11, pages 799 to 804. This method is based on the demonstration of remanent magnetism, a tensioning wire initially being magnetized. A magnetized ruptured steel wire then behaves like a ruptured bar magnet and a new magnetic dipole occurs in the vicinity of the point of rupture. The point of rupture can be located by measurement of the magnetic flux density transversely or vertically. At the point of rupture, two extreme values of the flux density with a point of inflection are visible. For carrying out the method, the tensioning wire is magnetized by an electromagnet and the magnetic field is measured by a mobile carriage from the surface.

A disadvantage of the method is that the entire surface of the structure has to be traveled over. Since structures are often not unrestrictedly accessible, the method often cannot be used, or it can be used only with great effort.

DE 36 06 836 A1 discloses a waveguide sensor for tensile forces which is formed as a radio-frequency coaxial cable and is embedded in a structure to be monitored. With the aid of a measuring device, the DC resistance or the characteristic wave impedance of the waveguide sensor is measured and used to determine a measure of a mechanical stress, such as tension, rupture or flexure. The waveguide sensor must disadvantageously be incorporated as a separate monitoring element in the structure to be monitored.

The object of the invention was therefore to provide an improved method for identifying the state of electrically conductive elongate tensioning elements with which simple subsequent testing of a tensioning element is possible.

The object is achieved by the method according to the invention with the steps of:

launching an electromagnetic measurement signal into a tensioning element;

changing the frequency of the measurement signal;

measuring the reflection spectrum of the measurement signal;

identifying the state of the tensioning element according to the resonant frequencies from the reflection spectrum.

According to the invention, the state of a tensioning element, in particular a rupture, is consequently determined with the aid of the resonant frequencies from the reflection spectrum of an electromagnetic measurement signal. The electromagnetic measurement signal can in this case be launched relatively easily at an exposed location of the tensioning element.

In this way, it is no longer necessary to travel over the entire length of the tensioning element

The reflection spectrum is dependent on the overall length and the distances of the tensioning elements from one another, and also on the dielectric properties of the material between the tensioning elements. Furthermore, the terminations of the tensioning elements and the launching of the electromagnetic signal have effects on the reflection spectrum. In the event of a rupture of the tensioning element, the effective length of the tensioning element and consequently the reflection spectrum changes for the electromagnetic wave of the measurement signal.

The evaluation of the measurement result takes place in various ways depending on the degree of coupling of the tensioning elements to one another.

In the case of tensioning elements which are coupled little, only the resonant frequencies of the excited tensioning element are included in the measurement result. The length l from the launching point of the measurement signal to a damage site can then be determined from the difference between two neighboring resonant frequencies Δf by the formula

$${l}_{ b} = \frac{c}{2 Δ f \sqrt{ϵ}} ,$$

where c is the speed of light in a vacuum and εᵣ is the dielectric constant of the medium surrounding the tensioning element. By comparison of the calculated rupture length l_{b} with the overall length l_{g} of the tensioning element, the existence of damage can be established. The determined rupture length l_{b} provides information on the approximate site of the damage. The method can be applied, since the difference Δf between every two neighboring resonant frequencies is constant.

If the dielectric constant is not known, a comparative measurement can be carried out on at least one corresponding comparison tensioning element of the same length. The rupture length l_{b} of the launching point of the measurement signal from a damage site can be determined in the comparative measurement from the differences between two neighboring resonant frequencies of the tensioning element Δfₗ, the difference between two neighboring resonant frequencies of the comparison tensioning element Δf₂ and the overall length l_{g} of the comparison tensioning element by the formula

$${l}_{ b} = \frac{{l}_{g} Δ {f}_{1}}{Δ {f}_{2}} .$$

In the case of coupled tensioning elements, additional resonances occur, with the result that the methods of calculation mentioned above cannot be used. Therefore, a method which is based on modeling of the coupled tensioning elements is proposed.

For this purpose, firstly the number n, the overall length l_{g} and the diameter d of the tensioning elements coupled to one another are determined. Moreover, the dielectric constant of the medium which is located between the tensioning elements, for example for concrete, is determined. Subsequently, a scattering matrix system of equations is devised for the model of the coupled tensioning elements and the reflection spectrum for the scattering matrix system of equations is calculated.

The calculated reflection spectrum is compared with the measured reflection spectrum and the parameters of the scattering matrix system of equations are iteratively adapted until the calculated reflection spectrum approximately coincides with the measured reflection spectrum. The state of the tensioning element can then be identified from the parameters of the scattering matrix system of equations.

The parameter which is substantially relevant for the iterative adaptation is the rupture length l_{b} between the launching point of the measurement signal and a damage site. Under some circumstances, the number of possibly damaged tensioning elements must also be adapted. Usually, however, the model will assume a number n-1 of tensioning elements at the damage site, i.e. a single damaged tensioning element.

The scattering matrix system of equations preferably comprises five scattering matrices, a first scattering matrix being intended for the launching portion of the coupled tensioning elements, a second scattering matrix being intended for the portion of the coupled tensioning elements between the launching portion and a point of rupture or fault, a third scattering matrix being intended for the portion of a point of rupture or fault, a fourth scattering matrix being intended for the portion of the coupled tensioning elements between the point of rupture or fault and the termination of the tensioning elements, and a fifth scattering matrix being intended for the terminating portion of the coupled tensioning elements.

The model consequently provides five individual regions of the tensioning elements that in themselves are longitudinally homogeneous and can be theoretically described as a model of coupled lines in a known way by scattering matrix system of equations.

For the launching of the electromagnetic measurement signal, a distinction must be made between two embodiments of the tensioning elements. For tensioning elements which do not have their ends connected to one another in an electrically conducting manner, i.e. which are terminated without an anchor plate, the electromagnetic measurement signal is launched at the end face of one tensioning element.

On the other hand, the electromagnetic measurement signal is launched on the circumference of the tensioning element at a distance from the end face if the ends of the tensioning elements are connected to one another in an electrically conducting manner, i.e. are terminated with an anchor plate.

The remaining tensioning elements, on which the electromagnetic measurement signal is not launched during a measurement, are preferably connected to ground potential. In the case of tensioning elements which are terminated with an anchor plate, the anchor plate may be connected to ground.

The method described for identifying the state of tensioning elements is suitable for detecting and locating prestressing steel ruptures both in the production phase and in the use phase of structures and components, such as for example tanks, steel-prestressed concrete bridges, back-anchored systems (sheet piling, etc.), beams, T-beams, prestressed- concrete prefabricated compound units, etc. It can typically be applied for checking the tensioning elements during and after the completion of a structure, for monitoring the state of tensioning elements when there are changes in the use and design of structures and for keeping a check on the state of the tensioning elements when there is a change in tensioning force (for example caused by deformations of the foundations or temperature fluctuations).

The invention is explained in more detail below on the basis of the accompanying drawings, in which:

FIG. 1 shows a diagram of three electrically conductive elongate parallel tensioning elements without an anchor plate, one tensioning element being ruptured:

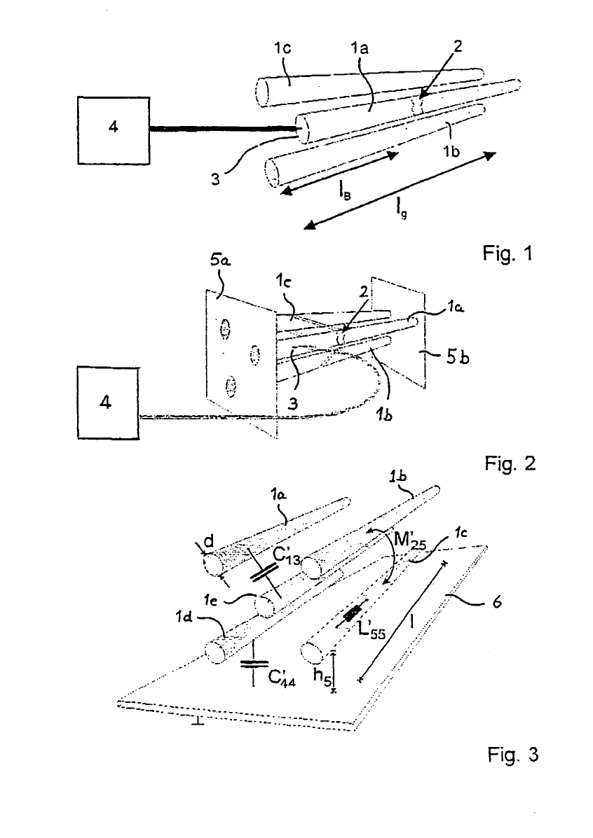

FIG. 2 shows a diagram of three electrically conductive elongate parallel tensioning elements which are terminated by an anchor plate, one tensioning element being ruptured;

FIG. 3 shows a schematic representation of the model of five parallel tensioning elements with parameters for the corresponding scattering matrix system of equations;

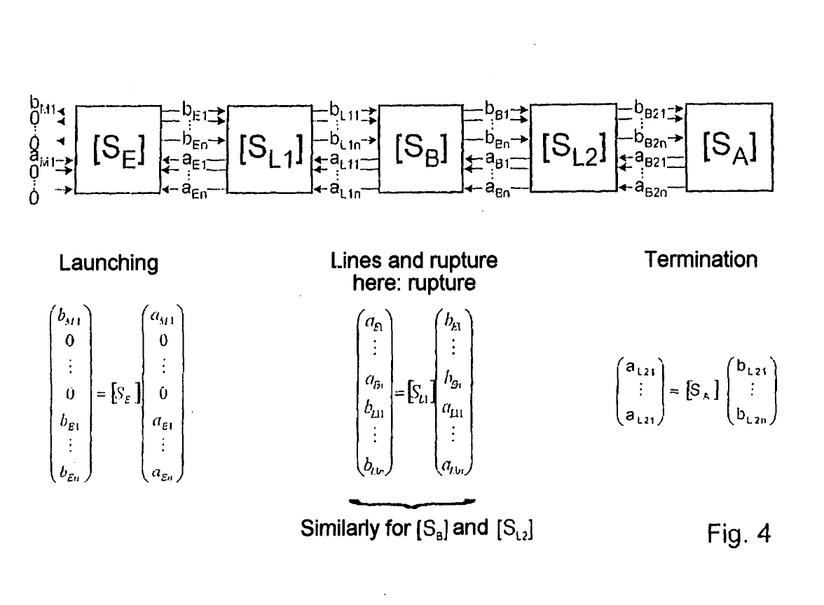

FIG. 4 shows a scattering matrix system of equations for the determination of a rupture site.

FIG. 1 shows three electrically conductive elongate parallel tensioning elements 1a, 1b and 1c, one of the tensioning elements 1a having a point of rupture 2. The point of rupture 2 is located at a rupture length l_{b} of the tensioning element 1a away from a launching point 3 for an electromagnetic measurement signal.

In order to determine the state of the tensioning elements, an electromagnetic measurement signal is launched at the launching point 3 into the tensioning element 1a and the frequency of the measurement signal changed. With a measuring system 4, which is connected to the launching point 3, the reflection spectrum of the electromagnetic measurement signal is measured and the resonant frequencies are determined from the reflection spectrum. The state of the tensioning element 1a is identified from the resonant frequencies. This is based on the realization that the electromagnetic wave is reflected at the point of rupture 2 and consequently the reflection spectrum is changed on account of the reduced length in comparison with an undamaged tensioning element 1b, 1c.

In the case of the system of tensioning elements 1 represented, which are not terminated by an anchor plate and also not connected to one another in an electrically conducting manner, the launching of the electromagnetic measurement signal takes place at the end face of a tensioning element 1a.

FIG. 2 shows another embodiment of a system of tensioning elements 1, which are terminated at their ends by an anchor plate 5. The launching of the electromagnetic measurement signal in this case takes place on the circumference of the tensioning element 1a at a defined distance behind the anchor plate 5a.

The evaluation of the resonant frequencies for the state identification takes place in various ways depending on the degree of coupling of the tensioning elements 1.

In the case of little coupling of the tensioning elements 1, only the resonances of the tensioning element 1a excited by the electromagnetic measurement signal are detectable. The difference Δf between every two neighboring resonances is in this case constant. Therefore, the difference between two neighboring resonant frequencies Δf can be used directly to conclude the rupture length l_{b} or the overall length l_{g} of the excited tensioning element la or the length from the launching point 3 of the measurement signal to a damage site 2 of the tensioning element 1a by the formula

$${l}_{ b , g} = \frac{c}{2 Δ f \sqrt{{ϵ}_{r}}} ,$$

where c is the speed of light in a vacuum (c=299.792×10⁵ m/s) and εᵣ is the dielectric constant of the material surrounding the tensioning elements 1 (for example concrete).

If the dielectric constant εᵣ is not known, a comparative measurement can be carried out on a comparison tensioning element 1b or 1c, the comparison tensioning element 1b or 1c having to correspond to the tensioning element 1a to be measured and be of the same length. In the comparative measurement, the rupture length l_{b} of the launching point of the measurement signal from a damage site can be determined from the difference Δf₁ between two neighboring resonant frequencies of the tensioning element 1a, the difference Δf₂ between two neighboring resonant frequencies of the comparison tensioning element 1b or 1c and the overall length l_{g} of the comparison tensioning element 1b or 1c by the formula

$${l}_{ b} = \frac{{l}_{g} Δ {f}_{1}}{Δ {f}_{2}} .$$

The aforementioned methods of calculation are not valid for tensioning elements 1 which are coupled greatly to one another, since additional resonances then occur.

For such systems, a state identification method which is based on modeling of a system of coupled lines is proposed.

For this purpose, the number n, the overall length l_{g} and the diameter d of the tensioning elements coupled to one another, and also the dielectric constant εᵣ of the medium which is located between the tensioning elements 1, are determined. Subsequently, a scattering matrix system of equations is devised in a known way for the model of the coupled tensioning elements 1 and the reflection spectrum for the scattering matrix system of equations is calculated. The calculated reflection spectrum is compared with the measured reflection spectrum and the parameters of the scattering matrix system of equations are iteratively adapted until the calculated reflection spectrum approximately coincides with the measured reflection spectrum. The state of the tensioning elements 1 is then identified from the parameters, in particular from the iteratively determined rupture length l_{b}, of the scattering matrix system of equations.

A model of coupled lines for coupled tensioning elements 1 is diagrammatically presented in FIG. 3. The system comprising five tensioning elements 1a, 1b, 1c, 1d and 1e takes into account the diameter d of the tensioning elements 1, their overall length l_{g} and the height h of a tensioning element 1 from a ground plane 6. Furthermore, the model takes into account the self inductances Lₙₙ of the tensioning elements, the capacitances Cᵢₙ between the tensioning elements 1ᵢ and 1ₙ, the capacitances of the tensioning elements 1ᵢ with the ground plane 6, and also the mutual inductance Mᵢₙ between the tensioning elements. The capacitances C and inductances L, M can be analytically determined for a system in a known way, with the result that the variables that are important for the modeling are left dependent only on the dimensions of the tensioning elements 1 and the dielectric constant εᵣ of the medium surrounding the tensioning elements 1.

The scattering matrix system of equations shown in FIG. 4 is divided into individual regions that are in themselves longitudinally homogeneous. In the simulation of a point of rupture 2 on a tensioning element 1a, five portions, i.e. five scattering matrices S_{E}, S_{L1}, S_{B}, S_{L2}, S_{A}, are provided.

A first scattering matrix S_{E} represents the launching portion of the coupled tensioning elements 1 either with or without an anchor plate 5a.

A second scattering matrix S_{L1} represents the portion of the coupled tensioning elements 1 between the launching portion 3 and a point of rupture or fault 2.

A third scattering matrix S_{B} is provided for the portion of the point of rupture or fault 2. This generally takes into account a single ruptured conductor or tensioning element and, given a number n of tensioning elements, n-1 intact conductors or tensioning elements 1.

A fourth scattering matrix S_{L2} takes into account the portion of the linked tensioning elements 1 behind the point of rupture or fault 2 up to the termination of the tensioning elements 1.

A fifth scattering matrix S_{A} is provided for the terminating portion of the linked tensioning elements 1 either with or without an anchor plate 5b.

These five scattering matrices S_{E}, S_{L1}, S_{B, S}_{L2}, S_{A} are arranged one behind the other in a known way and the reflection spectrum is determined from the scattering matrices by entering different frequencies in the scattering matrix system of equations. As represented, the output vectors of the system of a region are calculated by multiplication of the corresponding scattering matrix by an input vector.

The calculated reflection spectrum obtained from the modeling is iteratively adapted to the measured reflection spectrum, in order in this way to carry out a rupture identification or a rupture site determination.

1. A method for identifying the state of electrically conductive elongate tensioning elements (1) characterized by
launching an electromagnetic measurement signal into a tensioning element (1a);
changing the frequency of the measurement signal;
measuring the reflection spectrum of the measurement signal;
identifying the state of the tensioning element (1a) according to the resonant frequencies from the reflection spectrum.

2. The method as claimed in claim 1 for identifying the state of a little coupled electrically conductive elongate tensioning element (1), characterized by calculating the rupture length (l_{b}) from the launching point (3) of the measurement signal to a damage site from the difference between two neighboring resonant frequencies Δf by the formula
$${l}_{ b} = \frac{c}{2 Δ f \sqrt{{ϵ}_{r}}} ,$$
where c is the speed of light in a vacuum and εᵣ is the dielectric constant of the medium surrounding the tensioning element (1a).

3. The method as claimed in claim 2, characterized by
carrying out a comparative measurement on at least one corresponding comparison tensioning element (1b, 1c) of the same length;
calculating the rupture length (l_{b}) of the launching point (3) of the measurement signal to a damage site from the difference between two neighboring resonant frequencies of the tensioning element (1a) Δfₗ, the difference between two neighboring resonant frequencies of the comparison tensioning element (1b, 1c) Δf₂ and the overall length l_{g} of the comparison tensioning element (1b, 1c) by the formula
$${l}_{ b} = \frac{{l}_{g} Δ {f}_{1}}{Δ {f}_{2}} .$$

4. The method as claimed in claim 1 for identifying the state of coupled electrically conductive elongate tensioning elements (1), characterized by
determining the number n, the overall length l_{g} and the diameter d of the tensioning elements (1) coupled to one another;
determining the dielectric constant εᵣ of the medium which is located between the tensioning elements (1);
devising a scattering matrix system of equations for the model of the coupled tensioning elements (1);
calculating the reflection spectrum for the scattering matrix system of equations;
comparing the calculated reflection spectrum with the measured reflection spectrum;
iteratively adapting the parameters of the scattering matrix system of equations until the calculated reflection spectrum approximately coincides with the measured reflection spectrum;
identifying the state of the tensioning element (1) from the parameters of the scattering matrix system of equations.

5. The method as claimed in claim 4, characterized in that the scattering matrix system of equations comprises five scattering matrices,
a first scattering matrix being intended for the launching portion of the coupled tensioning elements (1),
a second scattering matrix being intended for the distance of the coupled tensioning elements (1) between the launching portion and a point of rupture or fault (2),
a third scattering matrix being intended for the portion of a point of rupture or fault (2),
a fourth scattering matrix being intended for the portion of the coupled tensioning elements (1) between the point of rupture or fault (2) and the termination of the tensioning elements (1), and
a fifth scattering matrix being intended for the terminating portion of the linked tensioning elements (1).

6. The method as claimed in one of the preceding claims, the ends of the tensioning elements (1) not being connected to one another in an electrically conducting manner, characterized by launching the electromagnetic measurement signal at the end face of a tensioning element (1).

7. The method as claimed in one of claims 1 to 5, the ends of the tensioning elements being connected to one another in an electrically conducting manner, characterized by launching the electromagnetic measurement signal on the circumference of a tensioning element (1) at a distance from the end face of the tensioning element (1).

8. The method as claimed in one of the preceding claims, characterized by connecting the remaining tensioning elements (1), on which the electromagnetic measurement signal is not launched, to ground potential.

9. A computer program with program coding means for carrying out the steps according to one of the preceding claims when the computer program is executed on a computer.

10. The computer program with program coding means as claimed in claim 9, which are stored on a computer-readable carrier.
